(19) United States
(12) Patent Application Publication
(10) Pub. No.: US 2008/0120544 A1
(43) Pub. Date: May 22, 2008

(54) Automated Generation of Agent Networks from Standard Ontologies

(75) Inventor: Nicholas Keith Treadgold, Tanunda (AU)

Correspondence Address: EDELL, SHAPIRO & FINNAN, LLC, 1901 RESEARCH BOULEVARD, SUITE 400, ROCKVILLE, MD, 20850, US

(73) Assignee: Sybase, Inc., Dublin, CA (US)

(21) Appl. No.: 11/942,763

(22) Filed: Nov. 20, 2007

Related U.S. Application Data
(60) Provisional application No. 60/866,810, filed on Nov. 21, 2006.

(51) Int. Cl. G06F 3/048

(52) U.S. Cl. 715/700

(57) ABSTRACT

The development of a natural language interface component can be highly manual and time-consuming. This is especially true when the problem being addressed is based on a class of back-end applications rather than one particular back-end application. Aspects of the present invention support the automated generation of a natural language interface component for a specified back-end application (or more precisely, the automated generation of a natural language interface component that is specific to the ontology for a specified back-end application domain) wherein the generated component includes an agent network.

This application claims the benefit of U.S. Provisional Patent Application No. 60/866,810, filed on Nov. 21, 2006, which is herein incorporated by reference in its entirety.

Attached is an appendix containing application source code in accordance with aspects of the present invention. The appendix contains material that is subject to copyright protection. The copyright owner has no objection to the facsimile reproduction by anyone of the patent document or the patent disclosure as it appears in the U.S. Patent and Trademark Office (PTO) files or records, but otherwise reserves all copyright rights whatsoever.

### BACKGROUND

1. Field of the Invention

The present invention relates generally to the generation, use, operation, etc. of agent networks. More particularly, the present invention relates to capabilities whereby an agent network may be developed in a highly automated manner from an ontology that may already be present in a particular back-end application.

2. Background of the Invention

“Natural language,” as the term is used herein, is a human language whose rules are based on usage rather than being pre-established. Examples include German, Japanese, and English. Typically it is an everyday language that real people speak, one that evolved naturally as opposed to being planned in advance. A natural language is often lose and ambiguous in interpretation, meaning different things to different hearers. The term as used herein is distinguished from computer languages, formal languages, artificial languages, and command sequence necessitated by the menu structure of a particular application.

“Natural language interpretation” is the process of deriving meaning from natural language user input through, for example, a natural language interface component.

The development of a natural language interface component can be highly manual and time-consuming. This is especially true when the problem being addressed is based on a class of back-end applications rather than one particular back-end application.

Thus it would be advantageous to be able to automatically generate a natural language interface component for a specified back-end application (or more precisely, to automatically generate a natural language interface component that is specific to the ontology for a specified back-end application domain) wherein the generated component includes an agent network.

The present invention provides innovatory capabilities, features, etc. that support such natural language interface component generation and addresses various of the (not insubstantial) challenges that are associated with same.

### SUMMARY OF THE INVENTION

Embodiments of the present invention provide . . .

These and other features of the embodiments of the present invention, along with their attendant advantages, will be more fully appreciated upon a reading of the following detailed description in conjunction with the associated drawings.

### BRIEF DESCRIPTION OF THE DRAWINGS

FIG. 1 illustrates one particular event sequence that is possible through aspects of the present invention.

FIG. 2 is an illustrative organization of ontological entities.

It should be understood that these figures depict embodiments of the invention. Variations of these embodiments will be apparent to persons skilled in the relevant art(s) based on the teachings contained herein.

### DETAILED DESCRIPTION

As noted above, “natural language,” as the term is used herein, is a human language whose rules are based on usage rather than being pre-established. Examples include German, Japanese, and English. Typically it is an everyday language that real people speak, one that evolved naturally as opposed to being planned in advance. A natural language is often lose and ambiguous in interpretation, meaning different things to different hearers. The term as used herein is distinguished from computer languages, formal languages, artificial languages, and command sequence necessitated by the menu structure of a particular application.

“Natural language interpretation” is the process of deriving meaning from natural language user input. In a typical environment, a natural language interpretation engine receives user input in a predefined format, such as a sequence of tokens, often in the form of text words and other indicators. The interpreter then attempts to discern the user's meaning from this input, and once an interpretation is made, it provides an appropriate command or set of commands to one or more back-end applications.

U.S. Pat. No. 6,144,989, which is herein incorporated by reference in its entirety, describes an adaptive agent oriented software architecture (AAOSA), in which an agent network is developed for the purpose of interpreting user input as commands and inquiries for a back-end application, such as an audiovisual system or a financial reporting system. User input is provided to the natural language interpreter in a predefined format, such as a sequence of tokens, often in the form of text words and other indicators. The interpreter sometimes needs to interact with the user in order to make an accurate interpretation, and it can do so by outputting to the user an inquiry or request for clarification. In addition, the back-end application also needs to be able to provide output to the user, such as responses to the user's commands, or other output initiated by the application. AAOSA is one example of a natural language interpreter. Another example is Nuance Communications' Nuance Version 8 (“Say Anything”) product, described in Nuance Communications' “Developing Flexible Say Anything Grammars, Nuance Speech University Student Guide (2001)” which is herein incorporated by reference in its entirety

Of the target applications that can be made to work with a natural language interface, many solve similar problems. There are multiple word processors, multiple banking web-sites, multiple stock researching applications. Each of these applications have different command names, command syntax and behavior, but within a particular class of applications they implement similar objects and other concepts. A user using a natural language interface to a particular class of back-end applications will likely use the same language to express his or her intent regardless of the particular application in the class. In fact it is one of the advantages of natural language interfaces that users do not have to know the particular command structures, menu structures, objects, and other concepts implemented by the particular back-end application, as long as it is known generally what the class of applications can do.

Because of similarities among applications in a particular class, a domain ontology can be developed for each class of applications. As used herein, a “domain ontology” is an explicit formal specification of how to represent the objects, concepts, and other entities that are assumed to exist in the domain of interest and the relationships that hold among them. In a typical implementation, the “domain of interest” is defined by one or more back-end applications, and may be, for example, the domain of contact managers, or the domain of finance managers, or the domain of audio/visual systems. If such an ontology is implemented in a natural language component, it is usually designed to mirror the ontology of the application's domain as closely as possible, but need not necessarily do so exactly. Thus the ontology of the natural language component need not be identical to that of the application's domain, though it is usually designed to be close.

In an AAOSA system the agent network is typically organized according to the ontology of the domain for which it is designed, with individual software agents and component agent networks representing the individual ontological entities—such as the individual commands, objects, and object fields—implemented by the back-end application domain. Other interpretation mechanisms could be used instead, however, which are organized around ontological entities but do not implement separate software entities for each one. These mechanisms are still considered herein to “implement” the ontological entities, even though no corresponding division of software entities can be found.

Natural language interpretation components organized around ontological entities of a back-end application domain can sometime become very large, containing tens or hundreds of entities. For each new application domain, a designer must establish all the rules or criteria by which the system will recognize in user input a reference to each of the ontological entities. Some groups of entities tend to appear repeatedly for different application domains, such as those involving dates and times; these groups of entities can be componentized and made available to designers as a unit in a library. But many other entities depend too heavily on the needs of the particular back-end application domain to be componentized in a library.

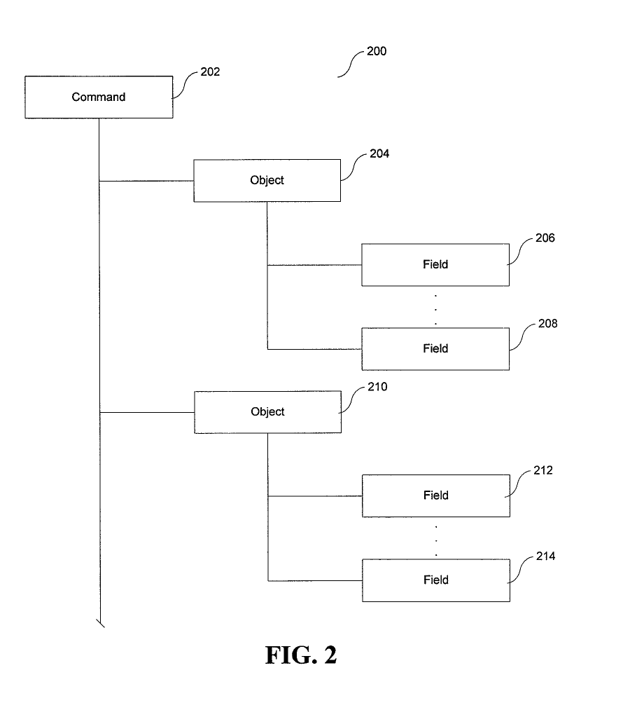

Even these entities, however, can usually be grouped into a few, specific “roles”, also called “categories” or “types,” depending on the semantic function of the entity in natural language user input. For example, as illustrated through FIG. 2 and reference numeral 200 three main semantic categories can be defined: commands (also called actions), objects, and fields (also called data). Various environments can use various categorizations, but these categorizations are preferred because they tend to correspond to the command structures used in a wide variety of back-end application domains. That is, commands in many application domains often involve a command (an action that the user desires to be performed), an object (the structure on which the action should be performed), and fields (within the specific object).

Thus an advantageous organization for an AAOSA agent network places command agents (agents whose function is to recognize the command part of user input) at a first level in a hierarchy, just below the root or top agent, object agents at second level in the hierarchy, and field agents at a third level in the hierarchy. The command agents are immediately downchain of the top agent, and the object agents in the second level are immediately downchain of at least one command agent. The field agents in the third level are immediately downchain of at least one object agent in the second level. In some networks, multiple object levels can precede the field level. The specific arrangement that was described above is illustrative only and it will be readily apparent to one of ordinary skill in the relevant art that numerous variations of the presented arrangement, as well as numerous other arrangements, are easily possible and indeed are fully within the scope of the present invention. In non-agent-based interpretation mechanisms, the same kind of organizations can be used if the mechanism has a hierarchical nature.

If the entity roles are chosen advantageously, they will tend to follow certain rules and relationships common for the role. Development of the interpretation component can then be simplified by allowing the designer to apply to each ontological entity a set of common rules and interpretation criteria that is basically the same, and predefined, for all entities having the same role. This is achieved through the use of templates that can be applied to ontological entities in order to automatically generate their interpretation criteria. The particular adaptations required for the individual needs of different entities having the same template can be established by the use of entity-specific template property values, which are referenced by the more generalized criteria set forth in the template. The rules and interpretation criteria for each individual agent are then generated using both the template and the list of template property values defined in the ontological entities. Through the use of templates, the prototyping and development time of natural language interpretation engines can be decreased significantly. Templates are described in detail in co-pending U.S. patent application Ser. No. 11/186,639, filed Jul. 21, 2005, which is herein incorporated by reference in its entirety.

A number of methodologies currently exist for the development of a natural language interface component for a particular back-end application or class of applications, whether the interface component is based on AAOSA or another mechanism. In one such methodology, the designer begins by collecting a corpus of sample user input to the system The corpus should involve sample input from a number of potential users, should cover as many potential scenarios as possible, and should include as many samples as possible for each scenario. The designer then develops a preliminary natural language interface component based on the corpus. In an AAOSA environment, the preliminary natural language interface component would include the preliminary topology for a basic agent network based on the corpus. This might be accomplished by initially proposing a separate agent for each of the application's functionalities (functions, subjects, and parameters or commands, objects, and fields), organizing them hierarchically in a way that agrees with the menu/form-based design of the application, and preparing interpretation policies for each agent based on the corpus. Templates can be used to expedite this step. Next, user tests are preformed and if the system is not yet ready, wither the corpus can be enhanced or the natural language interface component can be revised as needed, or both. This process iterates until satisfactory performance is achieved.

It can be seen that the development of a natural language interface component can be highly manual and time-consuming. This is especially true when the problem being address is based on a class of back-end applications, rather than a particular application. In this case the corpus-based development process described above essentially involves development of an ontology for the entire domain of the application class. For many individual applications, however, the ontology is already defined as part of the application. For many such applications, the ontology is even exposed outside the application, either through an Application Programming Interface (API), or through available documentation, or by other means. Thus in embodiments of the invention, a natural language user interface component is developed in a highly automated manner from the ontology already present in a particular back-end application. Once developed, the user interface component can be enhanced to accommodate other applications in the same class of applications as well.

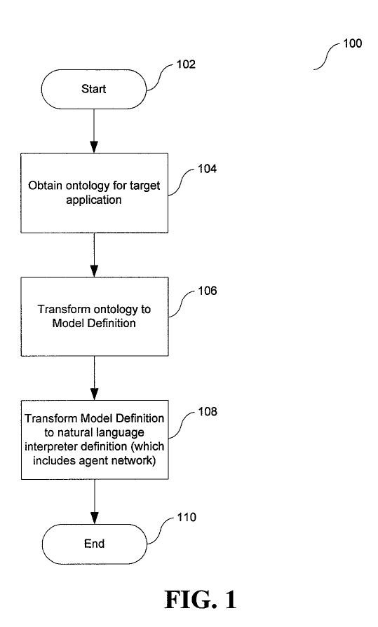

In embodiments of aspects of the instant invention the general flow of the automated process may be illustrated through FIG. 1 and reference numeral 100:

First an ontology is obtained for the target application 104.

Second the ontology definition is transformed to a Model Definition having a standardized syntax 106.

Third, the Model Definition is transformed in an automated way to the definition of a natural language interpreter 108. Preferably but not necessarily the natural language interpreter includes an AAOSA agent network, the definition of which can be represented and stored according to the “Opal” file format described, for example, in U.S. patent application Ser. No. 10/324,770, filed Dec. 20, 2002, which is herein incorporated by reference in its entirety.

It may be possible to develop an ontology translator that translates the ontology of an application directly in to the Opal file format, but the Opal file format is relatively complex and includes extensive information that the developer of an ontology translator does not need to be concerned with. For example, in addition to describing the topology of the agent network, it also defines the individual interpretation policies for all the agents, java classes for instantiating agents of particular types, information about hint and suggestion generation, information about utility agents not strictly part of the interpretation process, and information about the rendering of the agent network in a development environment. A more straightforward model definition format helps to isolate the ontology translator from the agent network. There may be many different OntologyTranslaters and by defining a simple ModelDefinition API developers of OntologyTranslaters do not have to understand the more complex Opal definition and do not have to repeatedly create code to create an Opal file.

In addition, the format of an Opal file may evolve over time as, possibly inter alia, new features are added to the agent network platform and earlier features are updated. The use of a separate Model Definition format as a target for ontology translators alleviates any need for ontology translators to be updated whenever the Opal file format changes. Only the ModelTranslater class (which translates a ModelDefinition to an Opal file) need be updated.

The OntologyDefinition may take many forms and is dependent on the source ontology. For example it may come from, possibly inter alia, the Cognitive Agent that Learns and Organizes (CALO) Chat Form ICL definition. As well, it may come from a user through a wizard facility. Another well-defined and automatically-obtainable ontology may be found within the Web Ontology Language (OWL), a semantic markup language for publishing and sharing ontologies on the World Wide Web (WWW), as defined for example at www.w3.org/TR/owl-ref which is herein incorporated by reference in its entirety. Another well-defined and automatically-obtainable ontology may be found within SOAP, as defined for example at www.w3.org.TR/2003/REC-soap12-part1-20030624 and www.w3.org.TR/2003/REC-soap12-part2-20030624 both of which are herein incorporated by reference in their entirety.

The transformation from OntologyDefinition to Model Definition is application specific and is performed by an application specific OntologyTranslater (the terms Translater and Transformer are used interchangeably herein). For a CALO-based application, a CaloFormOntologyTranslator may translate from the CALO Chat Form ICL to the Model Definition. For an application that does not have an automated way of obtaining the ontology definition, a wizard can be developed which will act as the OntologyTranslater prompting the user to define Commands, Objects, and Fields in order to create the Model Definition.

The Model Definition format is defined by CommandModelDefinition, ObjectModelDefinition, FieldModelDefinition, and RelationModelDefinition java classes, all of which extend the abstract EntityModelDefinition java class. Each EntityModelDefinition class stores, possibly inter alia, an associated AgentProperty and TemplateProperty map. An AgentProperty and TemplateProperty map each has a String key which is the property name and a corresponding Object value. The Agent and Template properties are applied to the created Agent represented by the EntityModelDefinition. In this way, the EntityModelDefintion of an Agent can be as detailed as the Agent itself and it is up to the OntologyTransformer to extract and translate as much relevant information from the ontology in to the appropriate AgentProperty entrys.

There is a method in each EntityModelDefinition class that will return a corresponding EntityDefinition class. For example, a CommandModelDefinition method will create a CommandDefinition. EntityDefinition classes are used by the FieldValidatorServiceProvider, which will be the default ServiceProvider created.

The transformation from Model Definition to an agent network is performed by a ModelTranslater. A ModelTranslater may, possibly inter alia, create a basic Agent layout, create all of the Agents defined in the Model Definition, apply the Agent and Template properties to the Agent, and create the correct message links between Agents. Preferably the ModelTranslator also adds all hooks required so that the agent network can be displayed in an agent network development environment to thereby permit further manual refinement of the network. The ModelTranslator also generates a list of synonyms using the existing synonym generation mechanism. These synonyms subsequently may be expanded either manually or via a local or internet based dictionary. The ModelTranslater may also create a ServiceProvider using the Model Definition. The type of ServiceProvider created may depend on the ontology. For example, for a database application the ServiceProvider created may be a DatabaseServidceProvider which may among other things implement all the functionality required to connect to and communicate with database tables defined by the Model Definition. If no specific ServiceProvider is defined in the ModelDefinition a default FieldValidatorServiceProvider may be created.

The ModelTranslater also creates XML and HTML ExplanationFormatters that may be added to a PresentationAgent. The Explanation and Display XML property files are generated automatically using the existing autogenerate functionality and applied to both Formatters.

The ModelTranslater also creates LiveInterpretationMatchers, which match vocabulary data stored by the application to a user's input. Since LiveInterpretationMatchers interact with the application, specific versions for the ontology may be created. For example, for a database application the OntologyTrasformer can specify that a LiveDatabaseMatcher be employed (where a LiveDatabaseMatcher is a LiveInterpretationMatcher for databases).

In addition, if the ontology defines a list of “valid” entries for a field the ModelTranslater may create a LiveInterpretationMatcher for the given field, which operation will perform matches against the “valid” entries for both Live Interpretation and Suggestion data. For examples of Suggestions see U.S. patent application Ser. No. 10/327,439, filed 20 Dec. 2002, which is herein incorporated by reference in its entirety. For example, an Importance field may define the “valid” values as low, medium, and high. These values may be added as data for the LiveInterpretationMatcher. Note that the “valid” values are also automatically added to the FieldValidatorServiceProvider since this ServiceProvider is created using the ModelDefinition.

Examples of Ontology Translators

CaloOntologyTranslater.java, which may be found in the attached source code appendix, is a small illustrative Java API for a CALO Form input Graphical User Interface (GUI). The example illustrated is a meeting scheduling application. A similar ontology translator can be developed for the full CALO ontology, which is well known and externally defined.

CaloOntologyTranslater_Test.java is a program for exercising the methods of CaloOntologyTranslater.java.

Another example ontology translator converts automatically from a database ontology. Here the database schema itself is interpreted as the ontology. An example for a database schema follows the same pattern as in the CaloOntology translator above:

```
  /* Get the database schema as an object we can parse */
  DatabaseSchema databaseSchema = createDbSchema
(aStringRepresentationOfTheDbSchema);
  /* Get a DatabaseSchemaOntologyTranslater */
  DatabaseSchemaOntologyTranslater
databaseSchemaOntologyTranslater = new
DatabaseSchemaOntologyTranslater ( );
  /* Get the model definition using the ontology translater */
  ModelDefinition modelDefinition =
databaseSchemaOntologyTranslater.getModelDefinition (databaseSchema,
Locale.getDefault( ).toString( ), generatedOpal);
  /* Create agent network using the model definition and a
synonym generator using the ModelTranslater class */
  AgentNetwork agentNetwork = ModelTranslater.createAgentNetwork
(modelDefinition, new PluralSynonymGenerator ( ));
```

ModelDefinition_Test.getModelDefinition( ) illustrates example code that performs the role of an OntologyTranslater. This illustrative code is organized to always produce the same ModelDefinition.

An ontology translator for developing a model definition automatically from a database schema can determine the various commands, objects, relations, and fields primarily from the definition of Structured Query Language (SQL) table creation. For example, the following SQL statement:

CREATE TABLE Person (LastName varchar (30), FirstName varchar,
Address Varchar, Age int (3))

may be translated by the DatabaseSchemaOntoologyTranslater in to a ModelDefinition with, possibly inter alia, command Find, object Person, and fields LastName, FirstName, Address, and Age.

Model Definition

Any format in which a hierarchy of commands, objects, fields, and relations can be represented would work as a Model Definition format. Preferably it is simple, however, so as to make it easy for third parties to develop ontology translators. The presently preferred model definition format is defined by a few simple data storage classes, as illustrated in the attached Appendix, with file names beginning with “ModelDefinition.” The illustrated files include:

ModelDefinition.java—the top level, stores all of the commands (e.g., CommandModelDefinition) and all of the properties for LiveInterpretation and SystemAgents.

EntityModelDefinition.java—a base class for FieldDefinitionDefinition, RelationModelDefinition, ObjectModelDefinition. Stores, among other things, its templates and agent properties, the name of an agent, and the name of a template.

CommandModelDefinition.java—stores all of the object information (e.g., ObjectDefinitionDefinition) and its own template and agent properties.

ObjectModelDefinition.java—stores all of the field information (e.g., FieldDefinitionDefinition) and its own template and agent properties.

RelationModelDefinition.java—a marker class for joining two objects in a relation (e.g., a Contact object has a Employer relationship with a Company object).

FieldDefinitionDefinition.java—stores its own template and agent properties and information about a field.

Example Actual Model Definition

Below is an example model definition that might be produced by an ontology translator for a very simple application that can find emails, contact, companies, and send emails. Comments have been added to help understand the content.

```
  // We have 2 commands - find and send
  CommandModelDefinition find = new CommandModelDefinition
(“find”);
  CommandModelDefinition send = new CommandModelDefinition
(“send”);
  // With 3 objects - email, contact, and company
  ObjectModelDefinition email = new ObjectModelDefinition
  (“Email”);
  ObjectModelDefinition contact = new ObjectModelDefinition
(“contact”);
  ObjectModelDefinition company = new ObjectModelDefinition
(“company”);
  // Add the objects to the commands
  find.addChild (email);
  find.addChild (contact);
  find.addChild (company);
  send.addChild (email);
  // Create the company name field - it can have 3 values
  List companyNames = new ArrayList ( );
  companyNames.add (new PossibleValue (“Sybase”, “1”));
  companyNames.add (new PossibleValue (“IBM”, “2”));
  companyNames.add (new PossibleValue (“iAnywhre”, “3”));
  FieldModelDefinition companyName = new FieldModelDefinition
(“companyName”, DataType.STRING, companyNames, false, false, true);
  // The company address field
  List empty = new ArrayList ( );
  FieldModelDefinition companyAddress = new FieldModelDefinition
(“companyAddress”, DataType.ADDRESS, empty, false, false, true);
  // Add company name and address fields to the company object
  company.addChild (companyName);
  company.addChild (companyAddress);
  // The contact name field
  List contactNames = new ArrayList ( );
  contactNames.add (new PossibleValue (“John Smith”, “1”));
  contactNames.add (new PossibleValue (“Peter Jones”, “2”));
  FieldModelDefinition contactName = new FieldModelDefinition
(“contactName”, DataType.NAME, contactNames, false, false, true);
  // The contact address
  FieldModelDefinition contactAddress = new FieldModelDefinition
(“contactAddress”, DataType.ADDRESS, empty, false, false, true);
  // Contacts have a relation to companies - create this
relation and add the company object
  RelationModelDefinition contactCompany = new
RelationModelDefinition (“employer”);
  contactCompany.addChild (company);
  // The fields are added to the contact object
  contact.addChild (contactName);
  contact.addChild (contactAddress);
  contact.addChild (contactCompany);
  // Emails can be sent to contacts - create this relation
  RelationModelDefinition sentTo = new RelationModelDefinition
(“sentTo”);
  sentTo.addChild (contact);
  // Add it to the email object
  email.childAdd (sentTo);
  // Emails can be sent from contacts - create the relation
  RelationModelDefinition sentFrom = new RelationModelDefinition
(“sentFrom”);
  sentFrom.addChild (contact);
  email.addChild (sentFrom);
  // The subject field for emails with some dummy possible
values
  List subjects = new ArrayList ( );
  subjects.add (new PossibleValue (“king kong”, “1”));
  subjects.add (new PossibleValue (“more movies”, “2”));
  FieldModelDefinition subject = new FieldModelDefinition
(“subject”, DataType.STRING, subjects, false, false, true);
  // The date field for emails
  FieldModelDefinition date = new FieldModelDefinition
(“sendDate”, DataType.DATE_TIME, empty, false, false, true);
  email.addChild (subject);
  email.addChild (date);
  // Finally create the model definition from the commands
  CommandModelDefinition[ ] modelCommands = new
CommandModelDefinition [2];
  modelCommands [0] = find;
  modelCommands [1] = send;
  ModelDefinition modelDefinition = new ModelDefinition
(generateOpal, Locale.getDefault ( ).toString ( ), modelCommands);
  Return modelDefinition;
```

It will be apparent to the reader how the above model definition would look in a diagram—very similar to the agent network that will ultimately be generated by the model translator. Note that fields with “complex” data types often result in component networks being added—e.g., DataType.DATE_TIME results in a DateTime component network being added.

Model Translator

An example model translator is set forth in the ModelTranslator.java file as found in the attached appendix. This class translates the Model Definition in the above format in to a AAOSA-based agent network. It creates the agents with many default entries for the more complex settings supported in the Opal file format, such as default template properties, default agent properties, and so on. If it happens that an OntologyTranslater requires non default settings it can, for example as illustrated in the attached java classes, set those by adding specifics to the ModelDefinition—using methods such as EntityModelDefinition.addAgentProperty( ), EnityModelDefinition.addTemplateProperty( ), ModelDefinition.addSystemAgentProperty( ), etc.

It will be readily apparent to one of ordinary skill in the relevant art that numerous alternatives to the arrangements that were described above are easily possible and indeed are fully within the scope of the present invention.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the relevant art in light of the above disclosure.

1. A method for the automated generation of an agent network, comprising:
obtaining an ontology for a specified application;
transforming said ontology to an ontology-independent model definition; and
transforming said ontology-independent model definition to a natural language interface component wherein said natural language interface component includes an agent network.

2. The method of claim 1, wherein the ontology is obtained via a XML avenue.

3. The method of claim 2, wherein the XML avenue is the Web Ontology Language (OWL).

4. The method of claim 2, wherein the XML avenue is the Simple Object Access Protocol (SOAP).

5. The method of claim 1, wherein the ontology is obtained via an Application Programming Interface.

6. The method of claim 1, wherein the ontology is obtained from a user via a wizard facility.

7. The method of claim 1, wherein the transformation of the ontology to the ontology-independent model definition is performed by an Ontology Translator.

8. The method of claim 7, wherein the Ontology Translator employs one or more templates.

9. The method of claim 7, wherein the Ontology Translator employs one or more components.

10. The method of claim 1, wherein the ontology-independent model definition contains one or more elements including (a) commands, (b) objects, (c) fields, and/or (d) relations.

11. The method of claim 10, wherein the elements are organized hierarchically.

12. The method of claim 1, wherein the transformation of the ontology-independent model definition to the agent network is performed by a Model Translator.

13. The method of claim 12, wherein the Model Translator employs one or more templates.

14. The method of claim 12, wherein the Model Translator employs one or more components.

15. The method of claim 12, wherein the Model Translator creates one or more (a) ontology-specific Service Providers, (b) synonyms, (c) Explanation Formatters, and/or (d) Live Interpretation Matchers.

16. The method of claim 15, wherein the Explanation Formatters are based on one or more of(a) XML and/or (b) HTML.

17. The method of claim 1, wherein the agent network is defined through one or more Opal files.
